(19) United States
(12) Patent Application Publication
(10) Pub. No.: US 2006/0014559 A1
(43) Pub. Date: Jan. 19, 2006

(54) Method and apparatus for recording of conversations by network signaling to initiate recording

(75) Inventor: Sundar Raman, Chicago, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTStarcom, Inc., Alameda, CA (US)

(21) Appl. No.: 10/710,516

(22) Filed: Jul. 16, 2004

(51) Int. Cl. H04Q 7/20

(52) U.S. Cl. 455/550.1

(57) ABSTRACT

A telephone conversation is transported over communications network equipment on an in-band channel between a first phone and a second phone. The telephone conversation is recordable in the communications network equipment. A user of the first phone controls whether or not to begin recording the telephone conversation by sending a record enable signal over an out-of-band channel. The communications network equipment contains a recorder responsive to the record enable signal.

### BACKGROUND OF THE INVENTION

1. Technical Field

The present invention relates to recording a cellular telephone conversation and, more particularly, relates to the initiation of recording a conversation on a cellular telephone network.

2. Description of the Related Art

Conversation recording is a vital feature to many telephone subscribers. The increase in telemarketing, conference calling and primarily business deals conducted over phone calls often demands a virtual paper-trail of the transactions. Many companies record conversations with clients for the purpose of “quality assurance”, but the recording is often used as evidence of acceptance of a service (e.g. cases of switching telephone carriers). The reverse (i.e., customers recording sales calls) is often a bothersome process, and this is particularly true in the case of cellular calls. Present-day conversation recording systems depend on either client-based recording approaches or server-side conference based recording approaches.

The client-based approaches require a recording device embedded in the client device, which stores a voice communication stream. Most cellphones require a series of navigation steps prior to arriving at the recording phase. Even in the event that the navigation is as simple as a single “record” button on the phone, the client device must have sufficient memory, and processing power to record the entire conversation. For this reason, conference and conversation recording systems have been implemented on the server-side.

The server-side conferencing systems require that a call initially be set up through a conferencing system, which allows the server to store all streams that pass through it. The conferencing server usually provides recording features, which allows parties on the conference to go back and review the contents of the call. The disadvantage of this approach is that a conference system must be subscribed to, and all parties must be notified. Server based systems typically have fallen into three different categories:

1. Call-center monitoring systems. These require that monitoring be interfaced with a PBX system. Also, these assume that the calls are being initiated via a system that acts as gateway.

2. Server systems based on conference calling. This is a variant of 1. Generally the mechanism is for all parties to be connected to a central server, i.e., call center. The conferencing system, be it hardware or software, is responsible for performing the recording.

3. Server based logging of a call. This again is a variant of 1 and 2, and requires that the caller call a number initially to initiate recording. The destination number then either acts as a conference server, or the client is responsible for bridging the subsequent calls.

### SUMMARY OF THE INVENTION

An object of the present invention is to provide a system that is inexpensive to implement without complex or expensive added features to handheld cellular telephone devices.

Another object of the present invention is to provide a system that is easy to alter based on the needs of the user.

A further object of the present invention is to provide a system that is simple to use—a single button on a phone could indicate start and stop of recording, vs. navigating a menu system to do this today on client devices.

An additional object of the present invention is to provide a system that can store information about the call—for instance called parties, time of call, duration of call, etc.

Also an object of the present invention is to provide a system where recording can be distributed as the client needs—the recording can be listened to on a home machine, on any client device, at a remote location via a suitable interface, or even played back to other parties without problem.

In the present invention, a telephone conversation is transported over communications network equipment on an in-band channel between a first phone and a second phone. The telephone conversation is recordable in the communications network equipment. A user of the first phone controls whether or not to begin recording the telephone conversation by sending a record enable signal over an out-of-band channel. The communications network equipment contains a recorder responsive to the record enable signal.

The details of the preferred embodiments of the invention will be readily understood from the following detailed description when read in conjunction with the accompanying drawings wherein:

### BRIEF DESCRIPTION OF THE DRAWINGS

FIG. 1 illustrates a schematic block diagram of communications equipment of the present invention;

FIG. 2 illustrates a schematic block diagram of a cellular telephone device of the present invention;

FIG. 3 illustrates a flow diagram of an approach using an Internet protocol based record indication; and

FIG. 4 illustrates a flow diagram of an alternative approach using a short message based record indication.

### DETAILED DESCRIPTION OF THE PREFERRED EMBODIMENTS

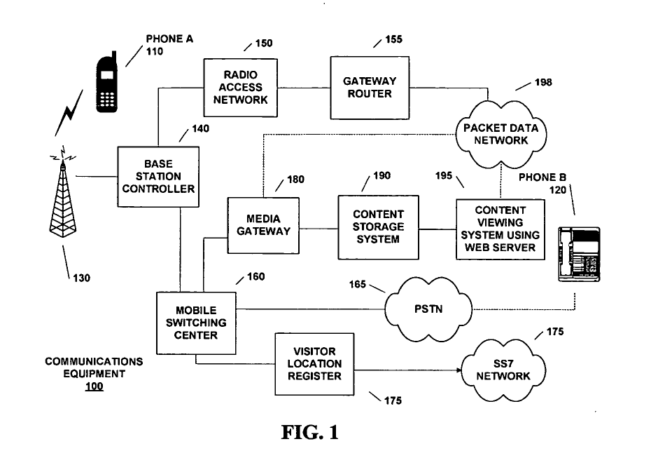

FIG. 1 illustrates a schematic block diagram of communications equipment 100. The communications equipment 100 provides for transport of a conversation between a first phone A 110 and a second phone B 120. The conversation is recordable in the communications equipment 100. A user of the first phone A 110 controls whether or not to record a telephone conversation. The phone preferably contains a button for initializing recording by sending a record enable signal from the first phone A 110 to tower 130 of the communications equipment 100. The communications equipment 100 contains a recorder connected to a cellular base station to receive the conversation over a traffic channel.

The first phone A 110 communicates with communications equipment 100 via traffic and signaling channels. Traffic channels generally transport voice; however, conversations may include any combination of voice and video. Traffic channels may be considered in-band. Any communication between the first phone A 110 and communications equipment 100 pertaining to control of the traffic channel is transported via the signaling channel. The signaling channel may be considered out-of-band. The signaling channel can contain a control channel for transporting the record control signal. Out-of-band channels may transport messages via an Internet protocol, Short Messaging Service (SMS), or proprietary control messaging schemes. The implementation of message transport is preferably via Internet protocol; however specific cellular networks may preferably implement SMS or other messaging protocols.

The record enable signal is transported from the first phone A110 to communications equipment 100 on an out-of-band channel. By transporting the record enable signal on an out-of-band signaling channel different from the in-band traffic channel, conversation traffic resources are not consumed for the record enable signal. Not only does transporting the record enable signal on this different channel improve performance, but some systems in-band voice channels may not be designed to carry such signaling traffic.

The tower 130 receives both the in-band communications and the out-of-band communications from the first phone A 110. A base station controller (BSC) 140 connects to the tower 130 and monitors both in-band traffic and out-of-band signaling channels. The out-of-band signaling channels may include any combination of signaling and control messages, SMS, and other data messages. The existence of signaling channels in packet-enabled cellular telephony, and the evolution of data services allowing for advanced packet-data services in cellular telephony (also known as 3^{rd} Generation or 3G Wireless) facilitate the implementation of out-of-band record-indication signaling.

The base station controller (BSC) 140 connects this traffic between the tower 130 and a radio access network (RAN) 150 and a mobile switching center (MSC) 160. In one exemplary implementation, using SMS for out-of-band transport of the record-enable signal, the phone A110 relays an SMS message to the mobile switching center (MSC) 160. The MSC is capable of receiving and understanding the SMS message. The MSC may, therefore, act on the SMS message it receives from the user of first phone A110. In the event that the user is “foreign”, or not registered to the current MSC, the MSC may further make use of the Visitor Location Register (VLR) to determine the “home” network for the user, and transport the SMS via the Signaling System 7 (SS7) network to the target home network.

The mobile switching center 160 carries the voice communication over public switched telephone network (PSTN) 165 to the second phone B 120. The second phone B 120 in the example of FIG. 1 is a landline based telephone. However, the second phone B 120 certainly can alternatively be a wireless cellular telephone.

The mobile switching center 160, upon receipt of the record enable indication, forks the voice communication and supplies one forked stream to the media gateway 180. The media gateway 180 may receive the voice communication in the standard cellular traffic encoding scheme. In this case, the media gateway may opt to compress or re-encode the conversation, for storage requirements. Although this is the preferred mechanism, the MSC may alternately encode the forked stream using an alternative scheme, such that the media gateway does not need to perform any further processing on the voice communication. The media gateway forwards the recorded conversation to the content storage system as streaming media using a standard digital encoding format, which can subsequently be translated to any other format, as the user requires. The digital encoding format may by standardized, such as Motion Picture Encryption Group (MPEG) (for example mpeg2, mp3, or mpeg4), wav, Real Media, or proprietary format.

The recorded conversation can be later retrieved using the content viewing system 195. The recording stored in the content storage system 190 is time-stamped. This makes the recording have credibility that might be lacking in the case of client devices, in the event of legal questions. Sharing of the recording with others is up to the user—an account management interface might provide a public/private sharing feature. The content viewing system 195 preferably uses a Web server with Web address for remote retrieval of the recorded conversation. The content viewing system 195 preferably addresses the participants to a conversation at the end of the recording either orally or visually using SMS. The participants are provided a Web address or other phone number or the like for retrieving the recorded conversation at a later time. At such Web address or other phone number, interactive menus are then provided having visual or audible menus for a user to control playback of the recorded conversation.

In an alternative approach of the record-enable feature, a radio access network 150 connects to a gateway router 155 and affords the communication to a packet data network 198. The gateway router 155 is preferably a PDSN or a GGSN. A GGSN is a Gateway GPRS Support Node for General Packet Radio Service used on a Group Special Mobile (GSM) cellular network. A PDSN is a Packet Switched Data Node used on a Code Division Multiple Access (CDMA) cellular network. The gateway router 155 carries Internet protocol based messages on the out-of-band channel and thus receives the out-of-band record enable signal from the first phone A110 and delivers this record enable signal to the media gateway 180. The media gateway 180 may then send an indication, via proprietary protocol or SMS to the MSC to trigger the MSC to fork-off a media stream to the media gateway. The encoding and transport of the forked conversation stream now proceeds in exactly the same manner as described above in the case of SMS-based signaling. The media gateway 180 communicates with the storage 190 and content viewing system 195, allowing for the recorded conversation to be available to the parties on the conversation.

The record enable signal from the first phone A110 in a further embodiment can comprise both a record start signal and record stop signal. Recording of the conversation is performed by the combined functions of the media gateway, the MSC and the content storage system. The record start signal triggers the commencement of conversation storage to the content storage system 190. The receipt of a record-stop signal causes conversation storage to the content storage system 190 to halt. Recording may be stopped either explicitly, via a record-stop signal, or when the conversation ends by either party in the conversation hanging up. An end of the conversation detected by the MSC, as termination of the session, and causes the MSC to terminate the forked media stream to the media gateway. The implicit termination of the stream is detected by the media gateway 180, which may communicate a “close session” message to the content storage system 190. Alternatively the content storage system 190 merely stops recording after a period of silence.

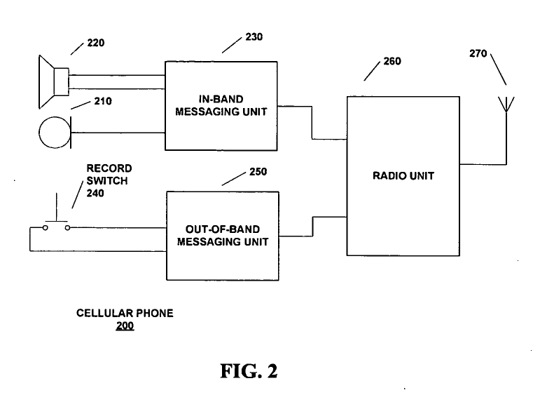

FIG. 2 illustrates a schematic block diagram of a cellular telephone device 200. A user of the cellular phone 200 uses microphone 210 and speaker 220 to communicate with an in-band messaging unit 230. When the user of the cellular phone 200 desires to start recording a conversation, a record switch 240 is activated. An out-of-band messaging unit 250 detects depression of the record switch 240 and initiates a record enable signal to a radio unit 260. The radio unit 260 modulates a cellular radio signal for communication over a cellular phone antenna 270 and communicates with the remote base station. For video conversation, a camera and display is also used in a phone.

When a user desires to stop recording record a conversation, the record switch 240 is preferably activated. The out-of-band messaging unit 250 detects activation on the record switch 240 and generates a record stop signal for transmission by the radio unit 260 to the base station.

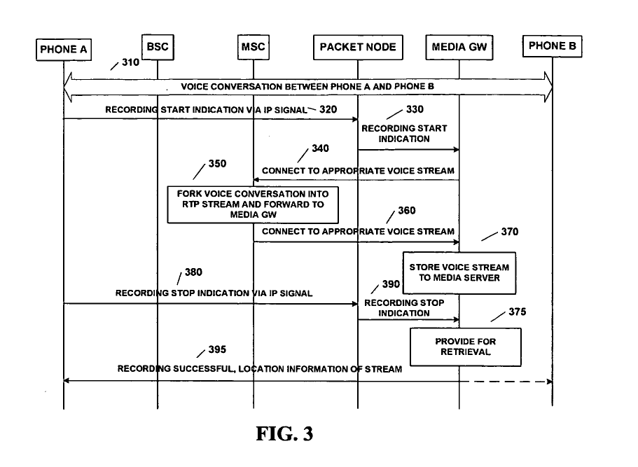

FIG. 3 illustrates a flow diagram of a first approach using an Internet protocol based record process. Phone A and Phone B communicate a conversation as illustrated in flow 310. Phone A indicates a recording start signal to the packet node by an Internet protocol signal in flow 320. The packet node then sends a recording start indication to the media gateway at flow 330. The media gateway then instructs the mobile switching center to fork the conversation into a real time protocol (RTP) stream and forward it to the media gateway at flow 340, flow 360 and process 350. A media gateway then stores the conversation stream on a media server at process 370. In the event phone A intends to stop recording, a record stop indicating signal is sent by Internet protocol in flow 380 to the packet node. A recording stop indication is sent to the media gateway from the packet node by flow 390.

The media gateway provides for retrieval of the recorded conversation at process 375. A stream providing indication of successful recording, and location information for subsequent retrieval of the recording, is provided to the user of the phone A by flow 395. The flow 395 can also provide this indication to the user of phone B if desired a by the preferences of the user of phone A.

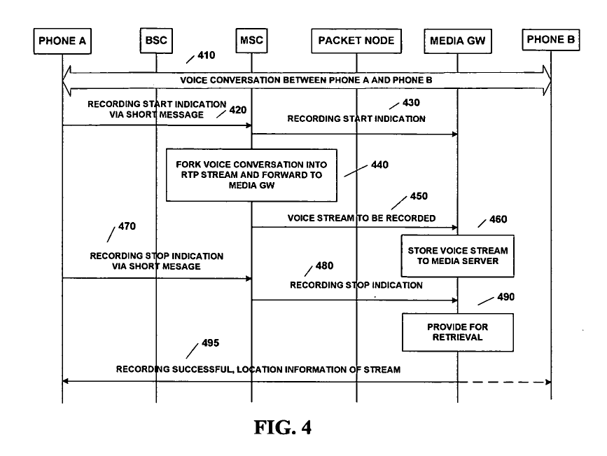

FIG. 4 illustrates a flow diagram of an alternative second approach using a short message (SMS) based record process. Phone A and Phone B communicate a voice conversation as illustrated in flow 410. Phone A indicates a recording start signal to the mobile switching center by short message SMS in flow 420. The mobile switching center then sends a recording start indication to the media gateway at flow 430. The mobile switching center then forks the conversation into a real time protocol RTP stream and forwards it to the media gateway at flow 440 and process 450. The media gateway then stores the forked stream on a media server at process 460. In the event phone A intends to stop recording, a record stop signal is sent by short message in flow 470 to the mobile switching center. A recording stop indication is then sent to the media gateway from the mobile switching center by flow 480.

The media gateway provides for retrieval of the recorded conversation at process 490. A stream providing indication of successful recording, and location information for subsequent retrieval of the recording, is provided to the user of the phone A by flow 495. The flow 495 can also provide this indication to the user of phone B if desired, by the preferences of the user of phone A.

Although the invention has been described and illustrated in the above description and drawings, it is understood that this description is by example only, and that numerous changes and modifications can be made by those skilled in the art without departing from the true spirit and scope of the invention. Although the examples in the drawings depict only example constructions and embodiments, alternate embodiments are available given the teachings of the present patent disclosure. For example, the above embodiment provides the exemplary instance of voice conversations. However, the embodiment may be expanded to include audio-visual conversations via the use of cellular videophone devices. A further example of an alternate embodiment is for phone B to control conversation recording. Moreover, different parties might perform recording enablement and disablement, such that phone A initiates record-start indication, and phone B performs the record-stop indication.

What is claimed is:

1. A cellular telephone device, comprising:
a radio unit for transmitting over a cellular telephone network, the cellular telephone network capable of both in-band communication and out-of-band communication;
a messaging unit operatively coupled to the radio unit to determine when a user of the cellular telephone device desires to record a cellular telephone conversation and, when the user of the cellular telephone device desires to record a cellular telephone conversation, to transmit a record enable signal via the radio unit using the out-of-band communication.

2. A cellular telephone device according to claim 1,
wherein the in-band communication is a traffic channel; and wherein the out-of-band communication is a signaling channel.

3. A cellular telephone device according to claim 2, wherein the in-band communication is a voice channel.

4. A cellular telephone device according to claim 2, wherein the out-of-band communication is a short message data channel.

5. A cellular telephone device according to claim 2, wherein the out-of-band communication is sent using an Internet protocol.

6. A cellular telephone device according to claim 2, wherein the out-of-band communication is a cellular data channel.

7. A cellular telephone device according to claim 1,
wherein the record enable signal comprises a record start signal and a record stop signal;
wherein the messaging unit is operatively coupled to the radio unit to transmit the record start signal via the radio unit using the out-of-band communication when the user of the cellular telephone device desires to start recording the cellular telephone conversation; and
wherein the messaging unit is operatively coupled to the radio unit to transmit the record stop signal via the radio unit using the out-of-band communication when the user of the cellular telephone device desires to stop recording the cellular telephone conversation.

8. Communications equipment capable of communicating with a remote cellular telephone device and of recording telephone conversations therewith, the communications equipment comprising:
a cellular base station for receiving a cellular telephone conversation with a remote cellular telephone device on an in-band channel and for receiving a record enable signal from the remote cellular telephone device on an out-of-band channel; and
a recorder operatively coupled to the cellular base station to receive the telephone conversation on the traffic channel and record the conversation upon the record enable signal.

9. Communications equipment according to claim 8, further comprising a media gateway operatively coupling the cellular base station to the public switched telephone network to transport telephone communications between the remote cellular telephone device and a remote public switched telephone device.

10. Communications equipment according to claim 8, wherein the in-band communication is a voice channel; and wherein the out-of-band communication includes a signaling channel to carry the record enable signal.

11. Communications equipment according to claim 8, wherein the in-band communication is a voice channel.

12. Communications equipment according to claim 10, wherein the out-of-band communication is a short message data channel.

13. Communications equipment according to claim 12, wherein the short message data channel uses SS7 signaling.

14. Communications equipment according to claim 10, wherein the out-of-band communication is sent using an Internet protocol.

15. Communications equipment according to claim 10, wherein the out-of-band communication is a cellular data channel.

16. Communications equipment according to claim 8, further comprising a mobile switching center operatively coupled to the cellular base station to fork off a communication signal to the recorder upon receipt of the enable signal.

17. Communications equipment according to claim 16, wherein the mobile switching center forwards the voice signal to the voice recorder using a streaming protocol.

18. Communications equipment according to claim 8,
wherein the record enable signal comprises a record start signal and a record stop signal;
wherein the cellular base station receives the record start signal from the remote cellular telephone device on an out-of-band channel; and
wherein the cellular base station receives the record stop signal from the remote cellular telephone device on an out-of-band channel; and
wherein the voice recorder receives the voice conversation on a voice channel and starts recording the voice conversation upon the record start signal and stops recording the voice conversation upon one of at least either the record stop signal and an end of the voice conversation.

19. Communications equipment according to claim 8, further comprising a media gateway operatively coupled to the cellular base station and the voice recorder to save and provide for future remote retrieval of the recorded conversation.

20. Communications equipment according to claim 19, wherein the media gateway provides for future remote retrieval of the recorded conversation using an interactive menu of at least one of visual and audible menus.

21. Communications equipment according to claim 19, wherein the media gateway forwards the recorded conversation to a distribution location using a standard digital encoded format, stores the conversation as a link on a website and provides the web address to each of the calling parties via at least one of voice message and text message.

22. A method of communicating over a cellular telephone to record voice conversations, the method comprising the steps of:
transporting a cellular telephone conversation between a remote cellular telephone device and a base station on an in-band communication;
transporting a record enable signal from the remote cellular telephone device to the base station on an out-of-band communication; and
recording the telephone conversation upon an enable signal.

23. A method according to claim 22, further comprising the step of transporting telephone communications between the remote cellular telephone and another telephone on a network.

24. A method according to claim 22,
wherein the in-band communication includes a voice channel; and
wherein the out-of-band communication includes a non-voice channel.

25. A method according to claim 24, wherein the out-of-band communication includes a signaling channel.

26. A method according to claim 24, wherein the out-of-band communication includes a short message data channel.

27. A method according to claim 26, wherein the short message data channel uses SS7 signaling.

28. A method according to claim 24, wherein the out-of-band communication is sent using an Internet protocol.

29. A method according to claim 24, wherein the out-of-band communication is a cellular data channel.

30. A method according to claim 22,
wherein the step of transporting a record enable signal comprises the steps of transporting a record start signal and transporting a record stop signal; and
wherein the step of recording the voice conversation upon an enable signal comprises the steps of starting recording the voice conversation upon the record start signal and stopping recording the voice conversation upon one of at least either the record stop signal and an end of the voice conversation.

31. A method according to claim 22, further comprising the step of saving and providing for future remote retrieval of the recorded conversation.

32. A method according to claim 22, wherein the step of providing for future remote retrieval of the recorded conversation further comprises the step of providing a website address to each of the calling parties via at least one of voice message and text message.
